(19) United States
(12) Patent Application Publication
(10) Pub. No.: US 2008/0040281 A1
(43) Pub. Date: Feb. 14, 2008

(54) USER-VENDOR MATCHING BASED ON REQUEST FROM MOBILE WIRELESS DEVICE

(76) Inventors: Dipanjan Chakraborty, Kolkata (IN); Koustuv Dasgupta, New Delhi (IN); Sumit Mittal, Uttar Pradesh (IN); Archan Misra, Irvington, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/456,738

(22) Filed: Jul. 11, 2006

(51) Int. Cl. H04L 9/00

(52) U.S. Cl. 705/52

(57) ABSTRACT

Users and vendors are matched. A request from a mobile wireless device of a user is received that relates to a business service. The request is matched against vendors providing the business service to yield one or more vendors currently locationally near the user and that are currently accepting service calls for the business service. A response is sent to the mobile wireless device of the user, with identities of the vendors that are locationally near the user and that are currently accepting service calls for the business service. The current location of the user may be determined based on the user's mobile wireless device. The current location of each vendor may be determined based on that provider's mobile wireless device. Whether each vendor providing the business service requested is currently accepting service calls is determined based on previously provided information by the provider.

### FIELD OF THE INVENTION

The present invention relates generally to mobile wireless devices, such as mobile wireless phones, and more particularly to matching a user to one or more vendors offering designated services based on a request received from the user via his or her mobile wireless device. More specifically, the invention is related to the notion of a “context-aware” or “live” directory service that uses dynamic attributes of both requesting users and vendors to perform improved matching of user requests received from mobile wireless devices of the users.

### BACKGROUND OF THE INVENTION

Mobile wireless devices, including mobile wireless phones, have become the primary way by which many people communicate. Traditionally, such mobile wireless phones were employed by people simply to make phone calls to other people. More recently, however, web-browsing, short-message service (SMS), and other functionality provided by such mobile wireless devices have been increasingly used by people for communication purposes.

Telecommunication providers have thus attempted to leverage these non-voice functionalities of mobile wireless devices as a way to increase revenue. For instance, many such telecommunication providers enable users to locate desired vendors. As one example, a user may use his or her phone to access a wireless-access protocol (WAP) interface to look up telephone book-style listings for vendors. A user may wish to locate pizza delivery vendors, plumber vendors, electrician vendors, and so on. As another example, a user may send a text message via SMS to the telecommunication provider requesting a given type of vendor, and receive the listings for such vendors in a text message response.

However, existing services provided by such telecommunication providers lack the ability to automatically track the dynamic attributes of various vendors, and use such dynamic attributes to improve the listing of vendors that is surfaced to individual users. Such dynamic attributes of the vendors can include the current location of the vendors, whether they are currently accepting service calls, and so on. Many times, a user is not provided with listings of desired vendors that are locationally near the user. Even when the user is provided with listings of desired vendors that are locationally near the user, the listings may be outdated. Alternatively or additionally, the listings do not guarantee that the vendors in question are currently accepting service calls for the type of service needed by the user.

For example, a user may need a plumber. Receiving a list of plumbers in response to a request made by the user on his or her mobile wireless device may not be overly helpful. In the first instance, not all the plumbers may be close to the user in locational proximity. Even if they are, in the second instance, not all the plumbers may be currently accepting service calls. That is, they may be busy on other calls. It is thus up to the user to call each plumber to determine first, if the plumber is locationally near the user, and second, if the plumber is available to provide a service call to the user.

For these and other reasons, therefore, there is a need for the present invention.

### SUMMARY OF THE INVENTION

The present invention relates to user-vendor matching based on a request from a mobile wireless device of the user. A method of an embodiment of the invention includes receiving a request from a mobile wireless device of a user, where the request relates to a business service. The request is matched against a database of vendors providing the business service to yield one or more vendors currently locationally near the user and that are currently accepting service calls for the business service. A response is sent to the mobile wireless device of the user, with identities of one or more of these vendors that are locationally near the user and that are currently accepting service calls for the business service.

For instance, as part of the matching process, the current location of the user may be determined based on the identifier of the user's mobile wireless device. Likewise, the current location of each vendor that provides the business service requested may be determined based on the identifier of that vendor's mobile wireless device. Whether each vendor providing the business service requested is currently accepting service calls is determined based on information explicitly provided by the vendor in question or inferred by the matching entity based on various dynamic attributes of the vendor.

A method of another embodiment of the invention includes receiving a message from a mobile wireless device of a vendor providing a business service. The message relates to whether the vendor is accepting service calls for the business service. A profile of the vendor within a database of vendors providing the business service is updated with whether the vendor is accepting service calls for the business service. The database is used to locate vendors providing business services requested from users via mobile wireless devices, who are locationally near the users, and who are currently accepting service calls.

A computerized system of an embodiment of the invention includes at least a database and a matching component. The database has entries corresponding to a number of vendors. Each entry includes an identifier of a mobile wireless device of a vendor, a business service provided by the vendor, and whether the vendor is currently accepting service calls for the business service. The matching component matches a request received from a mobile wireless device of a user for a business service against the database to yield one or more vendors currently locationally near the user and that are currently accepting service calls for the business service.

Embodiments of the invention provide for advantages over the prior art. Unlike as in the prior art, in the present invention a user making a request for vendors of a given business service receive the identity of one or more such vendors that satisfy two conditions. First, each such vendor is currently locationally near the user, or is predicted to be near the user's specified location at an appropriate future time if the user request indicates that the service is desired at some future time. For example, with respect to a plumber or an electrician, an embodiment of the invention is able to determine via the mobile wireless device of that vendor that the plumber or electrician's vehicle is near the location of the user, which is also determined via the mobile wireless device of the user. Thus, vendors who are currently located far away from the user do not have their identities provided to the user.

Second, each such vendor is currently accepting service calls. For example, also with respect to a plumber or an electrician, an embodiment of the invention is able to determine whether each such vendor is currently booked up or not, and thus whether each such vendor is currently able to accept a service call from the user. An embodiment of the invention may entail each vendor providing such information throughout each business day, for instance, or in a scheduled or other manner. Thus, vendors who are not currently accepting service calls do not have their identities provided to the user.

The user is therefore presented with a list of vendors providing the business service requested that are both locationally near the user, and that can accept the user's service call. The user does not have to concern himself or herself with whether a given vendor is located sufficiently close to provide service, nor with whether a given vendor is currently busy with other jobs and thus could not answer the user's service call.

Furthermore, in one embodiment of the invention, ratings from prior customer interactions with the vendors may be maintained. These ratings may be employed to alter the order in which vendors are presented to a user in response to a message from the user requesting such vendors. For example, if five vendors are all proximate to the user and available for receiving service calls, the vendors may be ordered according to their ratings from prior customer interactions. Alternatively, a user may request that he or she wishes to retain a vendor that has at least a given reputation rating. The user may also in his or her request provide values for other attributes that are matched against the vendors. For example, a user may indicate that a vendor charge no more than a certain amount for the business service being requested, such that just those vendors that charge no more than this amount are included.

It is also noted that in one embodiment, users may send requests for and receive responses relating to vendors in a number of different ways. A user may send a short text message via a short message service (SMS), or may access an appropriate wireless access protocol (WAP) interface. The user may also employ voicemail, send an email, or even make a regular voice phone call that is handled in an automated or a non-automated manner. The user may further send a message via a multimedia message service (MMS), among other types of ways by which a user may send requests and receive responses.

Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example and representative scenario in which a user is provided with a list of vendors, according to a preferred embodiment of the invention, and is suggested for printing on the first page of the patent.

FIG. 2 is a flowchart of a method for providing a list of vendors to a user in response to a request by the user, according to an embodiment of the invention.

FIG. 3 is a flowchart of a method for updating the profile of a vendor in response to a request by the vendor, according to an embodiment of the invention.

FIG. 4 is a flowchart of a method for updating a reputation rating of a vendor after a business service has been provided by the vendor to a user, according to an embodiment of the invention.

FIG. 5 is a rudimentary diagram of a computerized system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

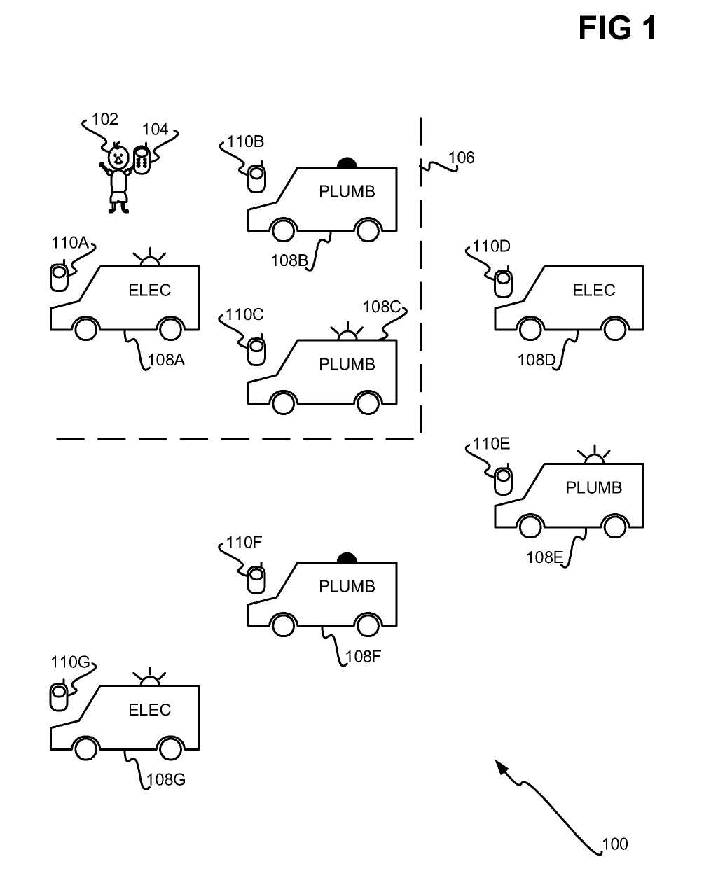

FIG. 1 shows an example scenario 100, according to an embodiment of the invention. The example scenario 100 is presented to provide an overall description of an embodiment of the invention, where various embodiments as to how this overall description can be implemented are presented in subsequent sections of the detailed description. Within the scenario 100 is a user 102 who has a mobile wireless device 104, which may be a wireless phone device. For sake of simplicity, in the example of FIG. 1, locational nearness or location farness is arbitrarily specified via the dotted line 106. That is, objects that are on the same side of the dotted line 106 as the user 102 are locationally near the user 102, whereas objects that are on the other side of the dotted line 106 as compared to the user 102 are not locationally near the user 102.

The scenario 100 includes a number of vendors 108A, 108B, 108C, 108D, 108E, 108F, and 108G, collectively referred to as the vendors 108. The vendors 108 are represented in FIG. 1 as trucks, to denote that they can themselves be mobile, and not be in the same location all the time. The vendors in the example scenario 100 provide one of two different types of business services, electrical services or plumbing services, as depicted in FIG. 1. As can be appreciated by those of ordinary skill within the art, however, other embodiments of the invention may be employed with more and/or different types of business services, and a given vendor may be able to provide more than one business service.

The vendors 108 have corresponding mobile wireless devices 110A, 110B, 110C, 110D, 110E, 110F, and 110G, collectively referred to as the mobile wireless devices 110. The mobile wireless devices 110 may be wireless phone devices. The mobile wireless devices 110 may be the personal mobile wireless devices of the vendor personnel driving the trucks of the vendors 108.

Each of the vendors 108 is available to receive service calls, or is unavailable to receive service calls, such as from the user 102. Whether a given vendor is able to currently receive service calls is illustratively indicated by a bulb on top of the vendor's truck in FIG. 1. A lit bulb indicates that the corresponding vendor is currently able to receive service calls. A dim bulb indicates that the corresponding vendor is not currently receiving service calls. The ability of a vendor to receive or not receive service calls may be determined by the vendor himself or herself. For instance, a vendor who is busy with other service calls may not be accepting new service calls.

Embodiments of the invention are primarily described in relation to a vendor that is mobile. However, other embodiments of the invention can relate to one or more of such vendors that are static—that is, that are not mobile.

In the scenario 100 of FIG. 1, the user 102 may issue a request from his or her mobile wireless device 104 for a business service. Consider an example in which the desired business service is plumbing. The request may be issued as a text message via short-message service (SMS), or via access of an appropriate wireless access protocol (WAP) interface. The request may further be issued by using voicemail, sending an email, or making a regular voice phone call. The request may also be issued by a message sent via multimedia message service (MMS).

In response, an embodiment of the invention may first determine which of the vendors 108 provide the corresponding business service. Of all seven of the vendors 108 in the example of FIG. 1, for instance, four vendors provide plumbing service: the vendors 108B, 108C, 108E, and 108F. For example, a database may be consulted that stores profiles for all the vendors 108, to determine which of the vendors provide plumbing service.

Next, it may be determined which of these vendors 108B, 108C, 108E, and 108F are currently accepting service calls. For instance, the database may be consulted to determine which of these vendors 108B, 108C, 108E, and 108F are currently accepting service calls. This determination may be made as part of the same inquiry as determining which vendors provide the requested plumbing service. The database may be updated as to the current service call acceptance status of a given vendor in response to requests made by that vendor. In the example of FIG. 1, of the vendors 108B, 108C, 108E, and 108F, just two are currently accepting service calls: the vendors 108C and 108E.

Next, an embodiment of the invention may determine the current location of the user 102 and the current location of each of the vendors 108C and 108E, to determine which of the vendors 108C and 108E are currently locationally near the user 102. Determining the current location of the user 102 may be achieved by determining the location of the mobile wireless device 104, by using triangulation, global positioning system (GPS), or another approach. Likewise, determining the current location of each of the vendors 108C and 108D may be achieved by determining the location of the corresponding mobile wireless device of each vendor.

Once the current locations of the user 102 and the vendors 108C and 108E, it can then be concluded that the vendor 108C is locationally near the user 102, whereas the vendor 108E is not locationally near the user 102. Therefore, a response is sent to the user 102 providing the identity of just the vendor 108C. The response may be sent as a text message via SMS, by using a WAP interface, by sending an email, by using a voice phone call, as a message via MMS, or in another manner. As such, the user 102 is provided with a vendor that provides plumbing services, that is locationally near the user, and that is currently accepting service calls. That is, the user 102 does not have to concern himself or herself that the vendor is not locationally near the user, or is not currently accepting service calls.

### Methods

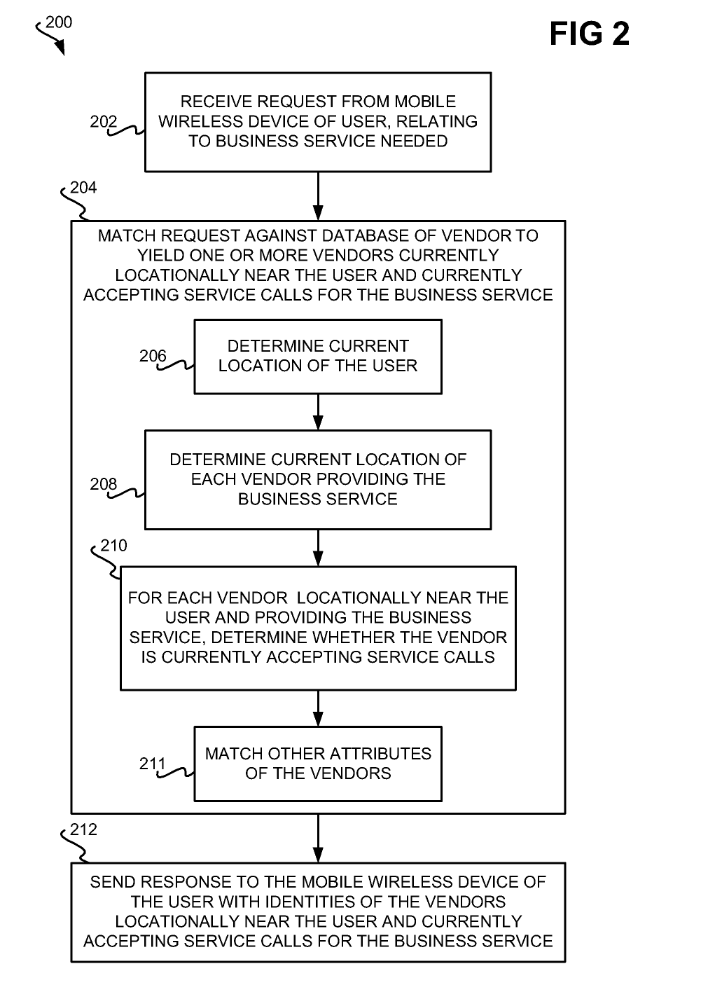

FIG. 2 shows a method 200, according to an embodiment of the invention. A request is received from a mobile wireless device of a user, for a business service that is needed by the user (202). The mobile wireless device may be a mobile wireless phone. The request may be received as a text message sent from the mobile wireless device via short-message service (SMS). Alternatively, the request may be received via a wireless access protocol (WAP) interface accessed by the mobile wireless device. The request may be received in another manner as well. For instance, the request may be received via voicemail, email, or a regular voice phone call. The request may also be received as a message sent via multimedia message service (MMS).

The request is matched against a database of vendors, to yield one or more vendors that are currently locationally near the user and that are currently accepting service calls for the business service requested by the user (204). This matching may be accomplished at least in part as follows. The current location of the user is determined (206). For instance, the current location may be determined based on an identifier of the mobile wireless device of the user, such as a phone number of this device. By using this phone number and an appropriate methodology, such as triangulation or global positioning system (GPS), the current location of the user may be determined.

Likewise, the current location of each vendor that is indicated in the database as providing the business service requested by the user is determined (208). For instance, as with the user, the current location of a vendor may be determined based on an identifier of the mobile wireless device of the vendor, such as a phone number, and an appropriate methodology. For each vendor that is locationally near the user and that provides the business service requested by the user, it is then determined whether the vendor is currently accepting service calls (210). Thus, all vendors who provide the business service requested by the user, are locationally near the user, and that are currently accepting service calls are identified.

In one embodiment, other attributes of the vendors may be matched against the request (211). Such other attributes can include the cost charged by a vendor to provide the business service requested, as well as the reputation of the vendor. For instance, a user may request that he or she wishes to retain a vendor that charges no more than a certain amount for the business service in question. Therefore, only those vendors that charge no more than this amount are included. Similarly, a user may request that he or she wishes to retain a vendor that has at least a given reputation rating, as rated by other customers of the vendor. Therefore, only those vendors that have at least this reputation rating are included. Alternatively, all such vendors may be included, but the vendors may be listed in accordance with their reputation ratings.

It is noted that the matching performed in part 204 of the method 200 of FIG. 2 may be performed in another way. For instance, an inquiry may be made against the database to determine all vendors providing the business service requested by the user and that are currently accepting service calls. Of this potentially smaller set of vendors, the location of each such vendor is then determined to determine which of this smaller set of vendors is locationally near the user. This alternative approach is functionally equivalent to that depicted explicitly in FIG. 2, however, and has an advantage in that the least possible number of vendors have their current locations determined.

Finally, a response is sent to the mobile wireless device of the user with the identity of each vendor that is locationally near the user and currently accepting service calls for the business service needed (212). For instance, a text message via SMS may be sent to the mobile wireless device of the user. The user may be provided with the name and phone number, for instance, of each such matching vendor. The method 200 of FIG. 2 thus outlines how vendors are matched to users based on the users' requested business service needs and their current locations.

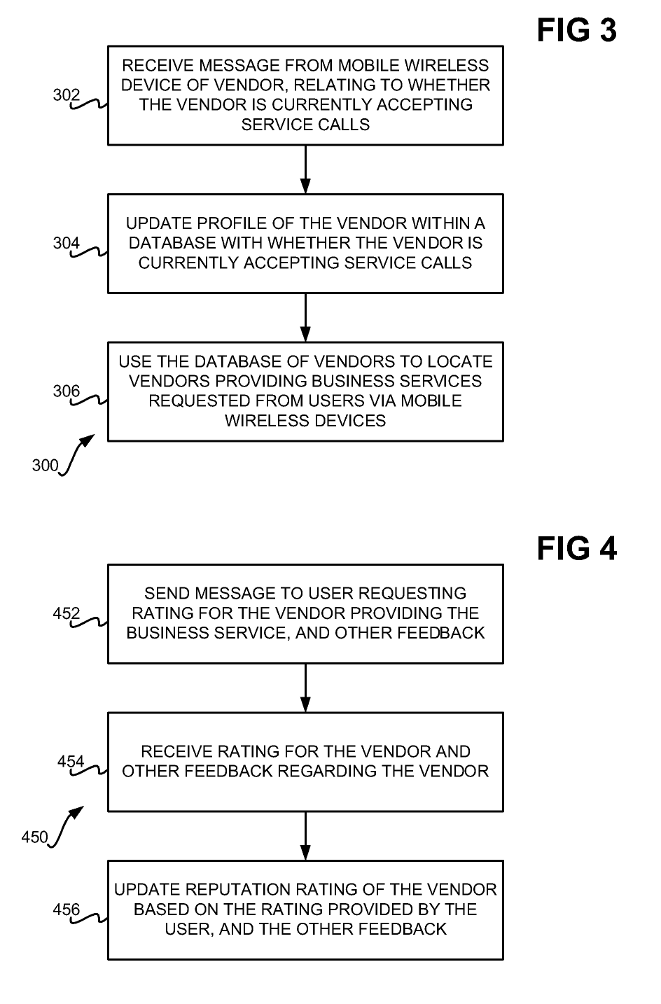

FIG. 3 shows a different method 300, according to an embodiment of the invention. In the method 300, a message is received from a mobile wireless device of a vendor, where the message provides information on whether the vendor is currently accepting service calls for the business service that the vendor performs (302). The mobile wireless device may be a mobile wireless phone, for instance. The message may be received as a text message over SMS, via a WAP interface, or in another manner, such as voicemail, email, a regular voice phone call, or an MMS message.

One type of message may indicate that the vendor is currently accepting service calls beginning at the time of transmission of the message, and will indefinitely continue accepting service calls until the vendor sends a later message indicating that service calls are no longer being accepted. Thus, another message may indicate that the vendor is currently not accepting service calls beginning at the time of transmission, and will indefinitely continue to not accept service calls until the vendor sends a later message indicating that service calls are now being accepted. A third type of message may specify a particular period of time and/or date in which the vendor is accepting service calls. Other information regarding the vendor, such as its name, phone number, base location, service rates, business services provided, and so on, may also be sent via such messages, or in another manner.

Therefore, the profile of the vendor within a database is updated with the information received in the message (304), such as whether or not the vendor is currently accepting service calls. This database is then employed to locate appropriate vendors in response to requests from users via their mobile wireless devices (306). For instance, part 306 of the method 300 of FIG. 3 may be achieved or implemented via the method 200 of FIG. 2 that has been described.

FIG. 4 shows another method 450, according to an embodiment of the invention. The method 450 is performed after a vendor has been retained by a user to provide a business service, and after the vendor has provided by the business service to the user. A message is sent to the mobile wireless device of the user, requesting that the user rate the vendor, and providing the user with the opportunity to provide other feedback regarding the vendor (452). This message may be sent via SMS, MMS, voicemail, email, a regular voice phone call, or via another manner.

In response, the user rates the vendor and optionally provides other feedback, such that the rating for the vendor and this other feedback are received (454). The rating and optional other feedback may be received via SMS, MMS, a WAP interface, voicemail, email, a regular voice phone call, or by another manner. The rating in particular may be specified as one of a number of different levels of satisfaction with the vendor, such as between one and five, a rating selected from “excellent,” “good,” “average,” “below average,” and so on.

The reputation rating of the vendor is then updated with this rating received, and the other feedback regarding the vendor, where provided, is recorded within the database (456). The reputation rating may be the average of all the ratings that this vendor received, or may be determined in a number of different ways, such as by weighting more recently received ratings from users more heavily than older ratings from user. In selecting a vendor to provide a given business service, a user may further have the opportunity to review the other feedback provided by other customers of the vendor, if any such feedback exists.

### Representative System and Conclusion

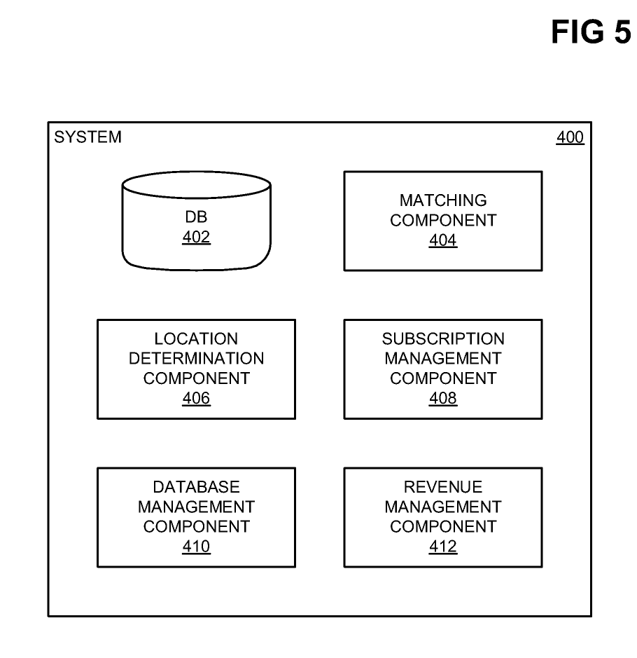

FIG. 5 shows a representative and rudimentary computerized system 400, according to an embodiment of the invention. The system 400 includes a database 402, as well as components 404, 406, 408, 410, and 412. As can be appreciated by those of ordinary skill within the art, the system 400 may include other components as well, in addition to and/or in lieu of those depicted in FIG. 5. Each of the components 404, 406, 408, 410, and 412 may be implemented in software, hardware, or a combination of software and hardware.

The database 402 has a number of entries corresponding to a number of vendors. Each entry stores an identifier of a mobile wireless device of a vendor, such as a phone number of a mobile wireless phone; one or more business services provided by the vendor; and, whether the vendor is currently accepting service calls. Each entry may store other information as well, such as the base location (i.e., a street address) of the vendor, the vendor's name, the vendor's rates for providing its business services, and so on.

The matching component 404 matches requests received from mobile wireless devices of users for business services against the database to yield matching vendors that are currently locationally near the user and that are currently accepting service calls for the business services requested. In this respect, the matching component 404 performs at least a portion of the method 200 of FIG. 2 that has been described. The matching component 404 interacts with the location determination component 406 to provide its matching functionality. The location determination component 406 determines the current location of a user based on an identifier of the user's mobile wireless device, as well as the current location of a vendor based on an identifier of the vendor's mobile wireless device, as has been described. Thus, the location determination component 406 may perform parts 206 and 208 of the method 200 of FIG. 2.

The subscription management component 408 updates entries within the database 402 with information received from corresponding vendors regarding whether the vendors are currently accepting service calls for the business services that they provide. In this respect, the subscription management component 408 performs at least a portion of the method 300 of FIG. 3 that has been described. Similarly, the database management component 410 updates entries within the database 402 with information received from corresponding vendors as to their name and base locations (i.e., their street addresses), their rates (i.e., their business service fee information), and so on. The database management component 410 can thus be considered as performing a portion of the method 300 of FIG. 3 where the request received from a vendor relates to such information.

Finally, the revenue management component 412 tracks charges to users and/or vendors for using the matching functionality provided by the computerized system 400. For instance, users may be charged each time they send a request, or they may pay a monthly fee for sending unlimited requests. As another example, vendors may be charged each time they are listed in a response made to a user's request, or each time they answer a service call in response to a user's request. As a final example, vendors may be charged a monthly fee to be included in matches made to user's requests. Other charging approaches may also be implemented by the revenue management component 412.

It is noted that in one embodiment, the methods that have been described are performed by a third party application that is hosted on the infrastructure of a telecommunications service provider. Thus, the third party is responsible for providing software that performs the methods, but the software is implemented on hardware of the telecommunication services provider. In another embodiment, however, the telecommunications service provider itself both provides the software that performs the methods, as well as hosts the infrastructure on which this software is implemented.

It is further noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
receiving a request from a mobile wireless device of a user, the request relating to a business service;
matching the request against a database of vendors providing the business service to yield one or more vendors currently locationally near the user and that are currently accepting service calls for the business service; and,
sending a response to the mobile wireless device of the user with identities of the vendors locationally near the user and that are currently accepting service calls for the business service.

2. The method of claim 1, wherein the mobile wireless device of the user is a mobile wireless phone.

3. The method of claim 1, wherein receiving the request from the mobile wireless device of the user comprises one of:
receiving a text message via short-message service (SMS);
receiving the request via a wireless access protocol (WAP) interface;
receiving a voicemail;
receiving an email;
receiving a voice phone call; and,
receiving a message via multimedia message service (MMS).

4. The method of claim 1, wherein matching the request against the database of vendors providing the business service comprises:
determining a current location of the user based on an identifier of the mobile wireless device; and,
determining a current location of each of a plurality of vendors within the database that provides the business service based on an identifier of a mobile wireless device of the vendor; and,
determining for each vendor within the database that provides the business service whether the vendor is currently accepting service calls, based on previously provided information by the vendor.

5. The method of claim 4, wherein the identifier of the mobile wireless device of the user is a phone number of the mobile wireless device of the user, and the identifier of the mobile wireless device of the vendor is a phone number of the mobile wireless device of the vendor.

6. The method of claim 1, wherein matching the request against the database of vendors providing the business service comprises determining whether each vendor charges no more than an amount for the business service as specified by the user.

7. The method of claim 1, wherein matching the request against the database of vendors providing the business service comprises matching the request against the database of vendors based on at least a reputation rating of each vendor as rated by other customers of the vendor.

8. The method of claim 1, wherein sending the response to the mobile wireless device of the user comprises one of:
sending a text message via short-message service (SMS);
using a wireless access protocol (WAP) interface;
using voicemail;
sending an email;
using a voice phone call; and,
sending a message via multimedia message service (MMS).

9. The method of claim 1, wherein the method is performed by one of:
software provided by a third party and implemented on hardware of a telecommunications service provider; and,
software provided by a telecommunications service provider and implemented on hardware of the telecommunications service provider.

10. The method of claim 1, further comprising, upon completion of the business service by a vendor selected by the user:
sending the user a message requesting a rating of the vendor and other feedback regarding the vendor, to the mobile wireless device of the user;
receiving at least the rating of the vendor from the user; and,
updating a reputation rating of the vendor within the database of vendors based on the rating of the vendor received from the user.

11. A method comprising:
receiving a message from a mobile wireless device of a vendor providing a business service, the message indicating relating to whether the vendor is accepting service calls for the business service;
updating a profile of the vendor within a database of vendors providing the business service, with whether the vendor is accepting service calls for the business service; and,
using the database of vendors to locate vendors providing business services requested from users via mobile wireless devices of the users, which are locationally near the users, and which are currently accepting service calls.

12. The method of claim 11, wherein the mobile wireless device of the user is a mobile wireless phone.

13. The method of claim 11, wherein the message indicates that the vendor is indefinitely available for accepting service calls for the business service beginning at time of transmission of the message until a later message is received indicating that the vendor is no longer available for accepting service calls for the business service.

14. The method of claim 11, wherein the message indicates that the vendor is indefinitely unavailable for accepting service calls for the business service beginning at time of transmission of the message until a later message is received indicating that the vendor is now available for accepting service calls for the business service.

15. The method of claim 11, wherein the message indicates that the vendor is available for accepting service calls for the business service during a period of time specified within the message.

16. The method of claim 11, wherein receiving the message from the mobile wireless device of the vendor comprises one of:
receiving a text message via short-message service (SMS);
receiving the message via a wireless access protocol (WAP) interface;
receiving a voicemail;
receiving an email;
receiving a voice phone call; and,
receiving the message via multimedia message service (MMS).

17. A computerized system comprising:
a database having entries corresponding to a plurality of vendors, each entry comprising an identifier of a mobile wireless device of a vendor, a business service provided by the vendor, and whether the vendor is currently accepting service calls for the business service; and,
a matching component to match a request received from a mobile wireless device of a user for a business service against the database to yield one or more vendors currently locationally near the user and that are currently accepting service calls for the business service.

18. The computerized system of claim 17, wherein the matching component is further to match the request against the database based at least on one or more of: an amount charged by each vendor to provide the business service requested, and, a reputation rating of each vendor as rated by other customers of the vendor.

19. The computerized system of claim 17, further comprising a location determination component to determine a current location of the user based on an identifier of the mobile wireless device and to determine a current location of each vendor within the database that provides the business service requested based on the identifier of the mobile wireless of the vendor.

20. The computerized system of claim 17, further comprising one or more of:
a subscription management component to update an entry within the database corresponding to a vendor with information provided in a request from the vendor received from the mobile wireless device of the vendor, the information comprising whether the service provide is currently accepting service calls for the business service provided by the vendor;
a database management component to update an entry within the database corresponding to a vendor with information provided in a request from the vendor, the information comprising the business service provided by the vendor, a name and address of the vendor, and business service fee information of the vendor; and,
a revenue management component to track charges to at least one of the user and the vendors for using the computerized system.
